(19) United States
(12) Patent Application Publication
(10) Pub. No.: US 2022/0128372 A1
(43) Pub. Date: Apr. 28, 2022

(54) METHOD FOR PATH PLANNING, ELECTRONIC DEVICE AND STORAGE MEDIUM

(71) Applicant: BEIJING BAIDU NETCOM SCIENCE TECHNOLOGY CO., LTD., Beijing (CN)

(72) Inventor: Jinzhu Lin, Beijing (CN)

(73) Assignee: BEIJING BAIDU NETCOM SCIENCE TECHNOLOGY CO., LTD., Beijing (CN)

(21) Appl. No.: 17/647,114

(22) Filed: Jan. 5, 2022

(30) Foreign Application Priority Data
Apr. 22, 2021 (CN) 202110437924.8

(51) Int. Cl. G01C 21/34

(52) U.S. Cl. CPC G01C 21/3461

(57) ABSTRACT

The disclosure provides a method for path planning, an electronic device and a storage medium. The method includes: obtaining a path planning request, in which the path planning request includes a path start point and a path end point located in different areas; determining a sequence of areas to be passed from the path start point to the path end point; determining a plurality of boundary adjacent points on a common boundary between any two adjacent areas in the sequence of areas; and determining a target path from the path start point to the path end point based on the path start point, the path end point, and the plurality of boundary adjacent points.

### CROSS REFERENCE TO RELATED APPLICATION

This application is based on and claims priority to Chinese Patent Application No. 202110437924.8, filed on Apr. 22, 2021, the entire content of which is hereby incorporated by reference.

### TECHNICAL FIELD

The disclosure relates to the field of data processing technologies, specifically to the field of intelligent transportation and cloud computing technologies, and in particular to a method for path planning, an electronic device and a storage medium.

### BACKGROUND

With rapid development of science and technology, people use a map application in clients for navigation more frequently. After a user sets a start point and an end point, the map application may plan a navigation path, so as to provide navigation services for the user based on the planned navigation path.

### SUMMARY

Embodiments of the disclosure provide a method for path planning, an electronic device and a storage medium.

According to a first aspect, the disclosure provides a method for path planning. The method includes: obtaining a path planning request, in which the path planning request includes a path start point and a path end point located in different areas; determining a sequence of areas to be passed from the path start point to the path end point; determining a plurality of boundary adjacent points on a common boundary between any two adjacent areas in the sequence of areas; and determining a target path from the path start point to the path end point based on the path start point, the path end point, and the plurality of boundary adjacent points.

According to a second aspect, the disclosure provides an electronic device. The electronic device includes: at least one processor and a memory communicatively connected to the at least one processor. The memory stores instructions executable by the at least one processor, and when the instructions are executed by the at least one processor, the at least one processor is configured to obtain a path planning request, in which the path planning request includes a path start point and a path end point located in different areas; determine a sequence of areas to be passed from the path start point to the path end point; determine a plurality of boundary adjacent points on a common boundary between any two adjacent areas in the sequence of areas; determine a target path from the path start point to the path end point based on the path start point, the path end point, and the plurality of boundary adjacent points.

According to a third aspect, the disclosure provides a non-transitory computer-readable storage medium storing computer instructions. The computer instructions are configured to cause a computer to execute the method for path planning. The method includes: obtaining a path planning request, in which the path planning request includes a path start point and a path end point located in different areas; determining a sequence of areas to be passed from the path start point to the path end point; determining a plurality of boundary adjacent points on a common boundary between any two adjacent areas in the sequence of areas; and determining a target path from the path start point to the path end point based on the path start point, the path end point, and the plurality of boundary adjacent points.

It should be understood that the content described in this section is not intended to identify the key or important features of the embodiments of the disclosure, nor is it intended to limit the scope of the disclosure. Additional features of the disclosure will be easily understood through the following description.

### BRIEF DESCRIPTION OF THE DRAWINGS

The drawings are used to better understand the solution and do not constitute a limitation of the disclosure, in which:

FIG. 1 is a flow chart illustrating a method for path planning according to a first embodiment of the disclosure.

FIG. 2 is a flow chart illustrating a method for path planning according to a second embodiment of the disclosure.

FIG. 3 is a schematic diagram illustrating path planning according to embodiments of the disclosure.

FIG. 4 is a flow chart illustrating a method for path planning according to a third embodiment of the disclosure.

FIG. 5 is a schematic diagram illustrating path planning according to embodiments of the disclosure.

FIG. 6 is a block diagram illustrating an apparatus for path planning according to a fourth embodiment of the disclosure.

FIG. 7 is a block diagram illustrating an electronic device configured for implementing a method for path planning according to an embodiment of the disclosure.

### DETAILED DESCRIPTION

The exemplary embodiments of the disclosure are described below in combination with the accompanying drawings, which include various details of the embodiments of the disclosure to aid in understanding, and should be considered merely exemplary. Therefore, those skilled in the art should know that various changes and modifications can be made to the embodiments described herein without departing from the scope and spirit of the disclosure. For the sake of clarity and brevity, descriptions of well-known features and structures have been omitted from the following description.

FIG. 1 is a flow chart illustrating a method for path planning according to a first embodiment of the disclosure. It is noted that the method of the embodiments of the disclosure may be applied to an apparatus for path planning of the embodiments of the disclosure, which may be configured in an electronic device. The electronic device may be a mobile terminal, for example, a cell phone, a tablet computer, a personal digital assistant, and other hardware devices having various operating systems.

As illustrated in FIG. 1, the method may include the following blocks.

At block 101, a path planning request is obtained, and the path planning request includes a path start point and a path end point located in different areas.

For example, a user may input the path planning request into a map application of a client, and the apparatus for path planning may obtain the path planning request input by the user. It is noted that the path planning request may include, but is not limited to, the path start point and the path end point located in different areas. For example, a path start point A and a path end point B are input into the map application, an area where the path start point A is located may be Asia, and an area where the path end point B is located may be America. That is, the path start point and the path end point may be located in different continents.

At block 102, a sequence of areas to be passed from the path start point to the path end point is determined.

Optionally, after obtaining the path start point and the path end point in the path planning request, the apparatus may determine a sequence of areas to be passed from the path start point to the path end point based on the path start point and the path end point.

For example, there are the path start point A and the path end point B, the area where the path start point A is located is Asia, and the area where the path end point B is located is America, thus the sequence of areas to be passed from the point A to the point B is Asia, Oceania and America.

At block 103, a plurality of boundary adjacent points on a common boundary between any two adjacent areas in the sequence of areas are determined.

In order to achieve cross-area path planning, in embodiments of the disclosure, after determining the sequence of areas to be passed from the path start point to the path end point, the boundary adjacency points on the common boundary between any two adjacent areas in the sequence of areas are determined. For example, the sequence of areas to be passed from the point A to the point B is Asia, Oceania and America, the boundary adjacency points on the common boundary between Asia and Oceania, and the boundary adjacency points on the common boundary between Oceania and America may be obtained from road network data.

At block 104, a target path from the path start point to the path end point is determined based on the path start point, the path end point, and the plurality of boundary adjacent points.

In order to achieve cross-area path planning and improve user experience, in embodiments of the disclosure, after obtaining the boundary adjacency points, the path planning from the path start point to the path end point may be achieved based on the boundary adjacency points.

For example, when the area where the path start point is located and the area where the path end point is located are adjacent areas, a path from the path start point to the boundary adjacency point may be determined, and a path between the boundary adjacency point and the path end point may be determined, such that the target path from the path start point to the path end point may be determined. For example, when the area where the path start point is located and the area where the path end point is located are not adjacent areas, the path between the path start point and the boundary adjacency point may be determined, and a path between one boundary adjacency point and another boundary adjacency point and the path between the boundary adjacency point and the path end point may be determined, such that the target path from the path start point to the path end point may be determined.

In conclusion, with obtaining the plurality of boundary adjacent points on the common boundary between any two adjacent areas in the sequence of areas to be passed from the path start point to the path end point and determining the target path from the path start point to the path end point based on the path start point, the path end point, and the plurality of boundary adjacent points, path planning crossing continents for the map may be realized, and the user experience may be improved.

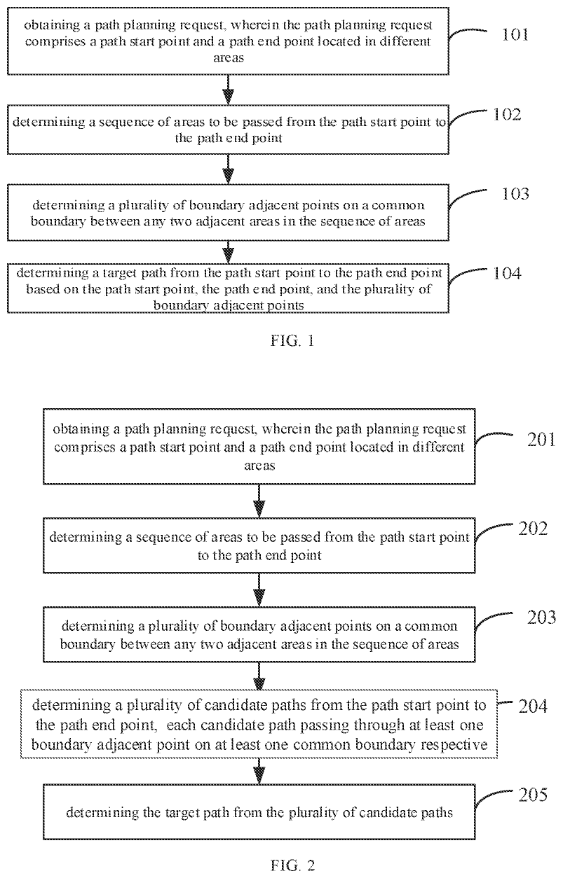

In order to improve the cross-area path planning and further enhance the user experience, as illustrated in FIG. 2, a method for path planning according to a second embodiment of the disclosure is provided. In the embodiments, after obtaining the boundary adjacency points on the common boundary of any two adjacent areas in the sequence of areas to be passed through from the path start point to the path end point, a plurality of candidate paths, that each candidate path passes through the at least one boundary adjacent point on the at least one common boundary respective, from the path start point to the path end point may be determined, and the target path may be determined based on the candidate paths. The method includes the following blocks.

At block 201, a path planning request is obtained, and the path planning request includes a path start point and a path end point located in different areas.

At block 202, a sequence of areas to be passed from the path start point to the path end point is determined.

At block 203, a plurality of boundary adjacent points on a common boundary between any two adjacent areas in the sequence of areas are determined.

In embodiments of the disclosure, a detailed description of the blocks 201-203 may be reference to blocks 101-103 of the embodiment described in FIG. 1 and will not be repeated in the disclosure.

At block 204, the plurality of candidate paths, that each candidate path passing through the at least one boundary adjacent point on the at least one common boundary respective, from the path start point to the path end point are determined.

In order to improve the cross-area path planning, in embodiments of the disclosure, the candidate paths may be determined in different ways depending on the number of areas in the sequence of areas to be passed from the path start point to the path end point.

For example, when the number of areas in the sequence of areas to be passed from the path start point to the path end point is two, that is, the area where the path start point is located and the area where the path end point is located are adjacent areas, each of the plurality of candidate paths is determined based on the path start point, the path end point, and each of the plurality of boundary adjacent points on the common boundary of the two areas in the sequence of areas.

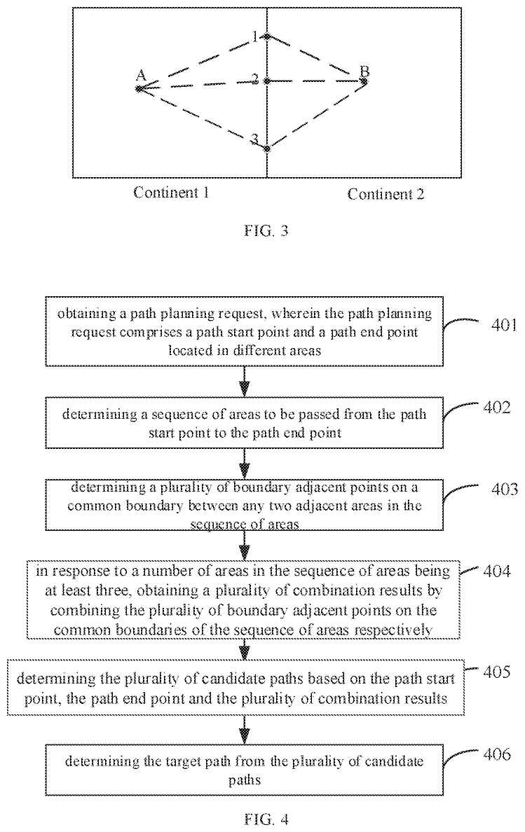

For example, as illustrated in FIG. 3, the path start point A is in Continent 1, the path end point B is in Continent 2, the sequence of areas to be passed from the path start point A to the path end point B includes two areas, thus, Continent 1 and Continent 2 are adjacent areas, and the boundary adjacency points on the common boundary between Continent 1 and Continent 2 include a boundary adjacency point 1, a boundary adjacency point 2, and a boundary adjacency point 3, respectively. The path start point A, the path start point B and each boundary adjacency point are combined to generate one candidate path, for example, a path between the path start point A and the boundary adjacency point 1 may be connected according to the road network data, and a path between the boundary adjacency point 1 and the path end point B may be connected according to the road network data, the path between the path start point A and the boundary adjacency point 1 and the path between the boundary adjacency point 1 and the path end point B may be combined, and a combination result is used as one candidate path.

For example, when the sequence of areas to be passed from the path start point to the path end point includes at least three areas, that is, the area where the path start point is located and the area where the path end point is located are not adjacent areas, the boundary adjacency points on respective common boundaries in the sequence of areas may be combined, the candidate paths are determined based on the path start point, the path end point and the combination result after combining. A detailed description may be reference to embodiments described in FIG. 4.

At block 205, the target path is determined from the plurality of candidate paths.

In an embodiment of the disclosure, after determining the candidate paths, one candidate path may be selected from the candidate paths as the target path.

For example, when there is multiple candidate paths, the target path may be selected based on distances of the candidate paths, e.g., a candidate path having a shortest distance may be determined as the target path.

In conclusion, with obtaining the plurality of boundary adjacent points on the common boundary between any two adjacent areas in the sequence of areas to be passed from the path start point to the path end point and determining the target path, that each candidate path passes through the at least one boundary adjacent point on the at least one common boundary respective, from the candidate paths from the path start point to the path end point, path planning s crossing continents in the map may be realized, and the user experience may be improved.

In order to more accurately determine the candidate path for better selecting the target path, as illustrated in FIG. 4, a method for path planning according to a third embodiment of the disclosure is provided. In the embodiments, in response to a number of areas in the sequence of areas being at least three, the plurality of boundary adjacent points on the common boundaries of the sequence of areas are respectively combined, a plurality of combination results are obtain, and the plurality of candidate paths are determined based on the path start point, the path end point and the plurality of combination results. The method includes the following blocks.

At block 401, a path planning request is obtained, and the path planning request includes a path start point and a path end point located in different areas.

At block 402, a sequence of areas to be passed from the path start point to the path end point is determined.

At block 403, a plurality of boundary adjacent points on a common boundary between any two adjacent areas in the sequence of areas are determined.

In the embodiments of the disclosure, a detailed description of the blocks 401-403 may be reference to blocks 101-103 of the embodiment described in FIG. 1 and will not be repeated in the disclosure.

At block 404, in response to the number of areas in the sequence of areas being at least three, the plurality of combination results are obtained by combining the plurality of boundary adjacent points on the common boundaries of the sequence of areas respectively.

For example, a directed graph may be obtained. The directed graph includes edges between every two adjacent common boundaries, each edge pointing from a boundary adjacent point on one common boundary pointing to a boundary adjacent point on the other common boundary. The combination results of the plurality of boundary adjacent points on the common boundaries of the sequence of areas are obtained by traversing the directed graph.

In other words, in order to more accurately determine the candidate paths, in embodiments of the disclosure, the directed graph may be obtained based on the boundary adjacent points on the adjacent common boundaries. The directed graph includes edges between every two adjacent common boundaries, each edge pointing from the boundary adjacent point on one common boundary pointing to the boundary adjacent point on the other common boundary. The combination results of the plurality of boundary adjacent points on the common boundaries of the sequence of areas may be obtained by traversing the directed graph. For example, the plurality of boundary adjacent points on the common boundaries are sequentially traversed via depth-first search and the combination results of the plurality of boundary adjacent points on respective common boundaries of adjacent areas in the sequence of areas may be obtained.

At block 405, the plurality of candidate paths are determined based on the path start point, the path end point and the plurality of combination results.

Optionally, for each combination result, an area path segment between an area where the path start point is located and an area where the path end point is located is determined based on the plurality of boundary adjacent points in the combination result. A start path segment from the path start point to a boundary of the area where the path start point is located is determined based on a boundary adjacent point located on the boundary of the area where the path start point is located and the combination result. An end path segment from a boundary of the area where the path end point is located to the path end point is determined based on a boundary adjacent point on the boundary of the area where the path end point is located and the combination result. A candidate path corresponding to the combination result is determined by combining the area path segment, the start path segment, and the end path segment.

In other words, for selecting the target path better, multiple candidate paths may be identified first. In the embodiments of the disclosure, after obtaining the plurality of combination results by combining the plurality of boundary adjacent points on the common boundaries of the sequence of areas, for each combination result, the area path segment between the area where the path start point is located and the area where the path end point is located is determined based on the combination result and the plurality of boundary adjacent points in the combination result, then the start path segment from the path start point to the boundary of the area where the path start point is located is determined based on the boundary adjacent point located on the boundary of the area where the path start point is located in the combination result, and the end path segment from the boundary of the area where the path end point is located to the path end point is determined based on the boundary adjacent point on the boundary of the area where the path end point is located in the combination result. The combination result is determined as the candidate path corresponding to the combination result is determined by combining the area path segment, the start path segment, and the end path segment.

To facilitate selection of the target path and to save relevant resources, after determining all the area path segments between the area where the path start point is located and the area where the path end point is located, a distance for each area path segment may be calculated offline, and an area path segment having a shortest distance is stored, for example, stored as a Hashmap, with key being a combination of IDs of two boundary adjacent points, value being an array of link sequences representing the shortest area path segment.

For example, as illustrated in FIG. 5, the path start point is located in Continent 1, the path end point is located in Continent 3, and the sequence of continents to be passed from the path start point to the path end point are Continent 1, Continent 2 and Continent 3. The boundary adjacent point on the common boundary between Continent 1 and Continent 2 is combined with the boundary adjacent point on the common boundary between Continent 2 and Continent 3, the area path segment (as illustrated in FIG. 5 with dotted lines in Continent 2) between the area where the path start point is located and the area where the path end point is located may be determined. The area path segment having the shortest distance is saved as shortcut, then the start path segment from the path start point to a boundary adjacent point on the common boundary between Continent 1 and Continent 2 is determined, and the end path segment from the path end point to the boundary adjacent point on the common boundary between Continent 2 and Continent 3 is determined, and the area path segment, start path segment and end path segment are combined to obtain the candidate path corresponding to the combination result of the boundary adjacent points.

At block 406, the target path is determined from the plurality of candidate paths.

For example, when there is multiple candidate paths, the target path may be selected based on the distances corresponding to the candidate paths, for example, the shortest candidate path is taken as the target path. For example, the distance of the start path segment and the distance of the end path segment may be calculated respectively, the shortest start path segment and the shortest end path segment may be obtained, and the corresponding shortest distance area path segment may be obtained by querying, and a candidate path combined the shortest distance start path segment, the shortest distance end path segment and the corresponding shortest distance area path segment is determined as the target path.

In conclusion, the boundary adjacency points on the common boundary of adjacent areas in the sequence of areas to be passed from the path start point to the path end point are obtained. When the number of areas in the sequence of areas from the path start point to the path end point is at least three, the plurality of boundary adjacent points on the common boundaries of the sequence of areas are respectively combined. Then the candidate paths are determined based on the path start point, the path end point and the combination results, and the target path is determined based on the candidate paths. Therefore, path planning s crossing continents in the map may be realized, and the user experience may be improved.

According to the method of the embodiments of the disclosure, the plurality of boundary adjacent points on the common boundary between any two adjacent areas in the sequence of areas to be passed from the path start point to the path end point are obtained. The target path from the path start point to the path end point is determined based on the path start point, the path end point, and the plurality of boundary adjacent points. Therefore, path planning crossing continents for the map may be realized, and the user experience may be improved.

In order to realize the above embodiments, embodiments of the disclosure also provide an apparatus for path planning.

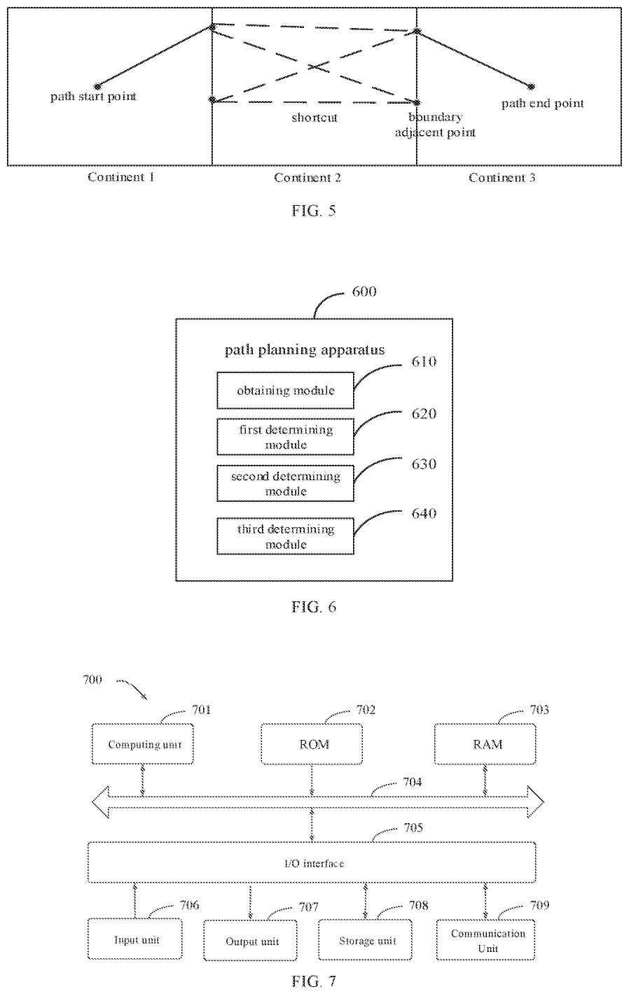

FIG. 6 is a block diagram illustrating an apparatus for path planning according to a fourth embodiment of the disclosure. As illustrated in FIG. 6, the apparatus 600 includes: an obtaining module 610, a first determining module 620, a second determining module 630, and a third determining module 640.

The obtaining module 610 is configured to obtain a path planning request, in which the path planning request comprises a path start point and a path end point located in different areas. The first determining module 620 is configured to determine a sequence of areas to be passed from the path start point to the path end point. The second determining module 630 is configured to determine a plurality of boundary adjacent points on a common boundary between any two adjacent areas in the sequence of areas. The third determining module 640 is configured to determine a target path from the path start point to the path end point based on the path start point, the path end point, and the plurality of boundary adjacent points.

In a possible implementation, the third determining module 640 includes: a determining unit and a selecting unit.

The determining unit is configured to determine a plurality of candidate paths from the path start point to the path end point, each candidate path passing through the at least one boundary adjacent point on the at least one common boundary respective. The selecting unit is configured to determine the target path from the plurality of candidate paths.

In a possible implementation, the determining unit is further configured to: in response to a number of areas in the sequence of areas being at least three, obtain a plurality of combination results by combining the plurality of boundary adjacent points on the common boundaries of the sequence of areas respectively; and determine the plurality of candidate paths based on the path start point, the path end point and the plurality of combination results.

In a possible implementation, the determining unit is further configured to: for each combination result, determine an area path segment between an area where the path start point is located and an area where the path end point is located based on the plurality of boundary adjacent points in the combination result; determine a start path segment from the path start point to a boundary of the area where the path start point is located based on a boundary adjacent point located on the boundary of the area where the path start point is located and the combination result; determine an end path segment from a boundary of the area where the path end point is located to the path end point based on a boundary adjacent point on the boundary of the area where the path end point is located and the combination result; and obtain a candidate path corresponding to the combination result by combining the area path segment, the start path segment, and the end path segment.

In a possible implementation, the determining unit is further configured to: obtain a directed graph, in which the directed graph comprises edges between every two adjacent common boundaries, and each edge pointing from a boundary adjacent point on one common boundary pointing to a boundary adjacent point on the other common boundary; and obtain the combination results of the plurality of boundary adjacent points on the common boundaries of the sequence of areas by traversing the directed graph.

In a possible implementation, the determining unit is further configured to: in response to a number of areas in the sequence of areas being two, determine each of the plurality of candidate paths based on the path start point, the path end point, and each of the plurality of boundary adjacent points on the common boundary of two areas in the sequence of areas.

With the apparatus according to the embodiments of the disclosure, a plurality of boundary adjacent points on a common boundary between any two adjacent areas in the sequence of areas to be passed from the path start point to the path end point are obtained. The target path from the path start point to the path end point is determined based on the path start point, the path end point, and the plurality of boundary adjacent points. Planning paths crossing continents in the map is realized, and the user experience is improved.

According to the embodiments of the disclosure, an electronic device, a readable storage medium and a computer program product are provided.

FIG. 7 is a block diagram illustrating an electronic device 700 configured for implementing a method for path planning according to an embodiment of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 7, the device 700 includes a computing unit 701 performing various appropriate actions and processes based on computer programs stored in a read-only memory (ROM) 702 or computer programs loaded from the storage unit 708 to a random access memory (RAM) 703. In the RAM 703, various programs and data required for the operation of the device 700 are stored. The computing unit 701, the ROM 702, and the RAM 703 are connected to each other through a bus 704. An input/output (I/O) interface 705 is also connected to the bus 704.

Components in the device 700 are connected to the I/O interface 705, including: an inputting unit 706, such as a keyboard, a mouse; an outputting unit 707, such as various types of displays, speakers; a storage unit 708, such as a disk, an optical disk; and a communication unit 709, such as network cards, modems, wireless communication transceivers, and the like. The communication unit 709 allows the device 700 to exchange information/data with other devices through a computer network such as the Internet and/or various telecommunication networks.

The computing unit 701 may be various general-purpose and/or dedicated processing components with processing and computing capabilities. Some examples of computing unit 501 include, but are not limited to, a central processing unit (CPU), a graphics processing unit (GPU), various dedicated artificial intelligence (AI) computing chips, various computing units that run machine learning model algorithms, and a digital signal processor (DSP), and any appropriate processor, controller and microcontroller. The computing unit 701 executes the various methods and processes described above. For example, in some embodiments, the method may be implemented as a computer software program, which is tangibly contained in a machine-readable medium, such as the storage unit 708. In some embodiments, part or all of the computer program may be loaded and/or installed on the device 700 via the ROM 702 and/or the communication unit 709. When the computer program is loaded on the RAM 703 and executed by the computing unit 701, one or more steps of the method described above may be executed. Alternatively, in other embodiments, the computing unit 701 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), erasable programmable read-only memories (EPROM or flash memory), fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (egg, a communication network). Examples of communication networks include: local area network (LAN), wide area network (WAN), the Internet and Block-chain network.

The computer system may include a client and a server. The client and server are generally remote from each other and interacting through a communication network. The client-server relation is generated by computer programs running on the respective computers and having a client-server relation with each other. The server may also be a server of a distributed system, or a server combined with a block-chain.

Artificial Intelligence (AI) is a discipline that studies certain thinking processes and intelligent behaviors (such as learning, reasoning, thinking and planning) that allow computers to simulate life, which has both hardware-level technologies and software-level technologies. Artificial intelligence hardware technology generally includes technologies such as sensors, dedicated artificial intelligence chips, cloud computing, distributed storage, and big data processing. Artificial intelligence software technology generally includes computer vision technology, speech recognition technology, natural language processing technology, and its learning/deep learning, big data processing technology, knowledge map technology and other aspects.

In addition, the acquisition, storage and application of the information involved in the technical solution of the disclosure are in accordance with the relevant laws and regulations and do not violate public order and morality.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for path planning, comprising:
obtaining a path planning request, wherein the path planning request comprises a path start point and a path end point located in different areas;
determining a sequence of areas to be passed from the path start point to the path end point;
determining a plurality of boundary adjacent points on a common boundary between any two adjacent areas in the sequence of areas; and
determining a target path from the path start point to the path end point based on the path start point, the path end point, and the plurality of boundary adjacent points.

2. The method according to claim 1, wherein determining the target path from the path start point to the path end point based on the path start point, the path end point, and the plurality of boundary adjacent points, comprises:
determining a plurality of candidate paths from the path start point to the path end point, each candidate path passing through at least one boundary adjacent point on at least one common boundary respective; and
determining the target path from the plurality of candidate paths.

3. The method according to claim 2, wherein determining the plurality of candidate paths from the path start point to the path end point, each candidate path passing through the at least one boundary adjacent point on the at least one common boundary respective, comprises:
in response to a number of areas in the sequence of areas being at least three, obtaining a plurality of combination results by combining the plurality of boundary adjacent points on the common boundaries of the sequence of areas respectively; and
determining the plurality of candidate paths based on the path start point, the path end point and the plurality of combination results.

4. The method according to claim 3, wherein determining the plurality of the candidate paths based on the path start point, the path end point, and the plurality of combination results comprises:
for each combination result, determining an area path segment between an area where the path start point is located and an area where the path end point is located based on the plurality of boundary adjacent points in the combination result;
determining a start path segment from the path start point to a boundary of the area where the path start point is located based on a boundary adjacent point located on the boundary of the area where the path start point is located and the combination result;
determining an end path segment from a boundary of the area where the path end point is located to the path end point based on a boundary adjacent point on the boundary of the area where the path end point is located and the combination result; and
obtaining a candidate path corresponding to the combination result by combining the area path segment, the start path segment, and the end path segment.

5. The method according to claim 3, wherein obtaining the plurality of combination results by combining the plurality of boundary adjacent points on the common boundaries of the sequence of areas comprises:
obtaining a directed graph, wherein the directed graph comprises edges between every two adjacent common boundaries, and each edge pointing from a boundary adjacent point on one common boundary pointing to a boundary adjacent point on the other common boundary; and
obtaining the combination results of the plurality of boundary adjacent points on the common boundaries of the sequence of areas by traversing the directed graph.

6. The method according to claim 2, wherein determining the plurality of candidate paths from the path start point to the path end point, each candidate path passing through the at least one boundary adjacent point on the at least one common boundary respective comprises:
in response to a number of areas in the sequence of areas being two, determining each of the plurality of candidate paths based on the path start point, the path end point, and each of the plurality of boundary adjacent points on the common boundary of two areas in the sequence of areas.

7. An electronic device, comprising.
at least one processor; and
a memory communicatively connected to the at least one processor; wherein,
the memory stores instructions executable by the at least one processor, when the instructions are executed by the at least one processor, the at least one processor is configured to:
obtain a path planning request, wherein the path planning request comprises a path start point and a path end point located in different areas;
determine a sequence of areas to be passed from the path start point to the path end point;
determine a plurality of boundary adjacent points on a common boundary between any two adjacent areas in the sequence of areas; and
determine a target path from the path start point to the path end point based on the path start point, the path end point, and the plurality of boundary adjacent points.

8. The electronic device according to claim 7, wherein the at least one processor is configured to:
determine a plurality of candidate paths from the path start point to the path end point, each candidate path passing through at least one boundary adjacent point on at least one common boundary respective; and
determine the target path from the plurality of candidate paths.

9. The electronic device according to claim 8, wherein the at least one processor is configured to:
in response to a number of areas in the sequence of areas being at least three, obtain a plurality of combination results by combining the plurality of boundary adjacent points on the common boundaries of the sequence of areas respectively; and
determine the plurality of candidate paths based on the path start point, the path end point and the plurality of combination results.

10. The electronic device according to claim 9, wherein the at least one processor is configured to:
for each combination result, determine an area path segment between an area where the path start point is located and an area where the path end point is located based on the plurality of boundary adjacent points in the combination result;
determine a start path segment from the path start point to a boundary of the area where the path start point is located based on a boundary adjacent point located on the boundary of the area where the path start point is located and the combination result;
determine an end path segment from a boundary of the area where the path end point is located to the path end point based on a boundary adjacent point on the boundary of the area where the path end point is located and the combination result; and
obtain a candidate path corresponding to the combination result by combining the area path segment, the start path segment, and the end path segment.

11. The electronic device according to claim 9, wherein the at least one processor is configured to:
obtain a directed graph, wherein the directed graph comprises edges between every two adjacent common boundaries, and each edge pointing from a boundary adjacent point on one common boundary pointing to a boundary adjacent point on the other common boundary; and
obtain the combination results of the plurality of boundary adjacent points on the common boundaries of the sequence of areas by traversing the directed graph.

12. The electronic device according to claim 8, wherein the at least one processor is configured to:
in response to a number of areas in the sequence of areas being two, determine each of the plurality of candidate paths based on the path start point, the path end point, and each of the plurality of boundary adjacent points on the common boundary of two areas in the sequence of areas.

13. A non-transitory computer readable storage medium storing computer instructions, wherein the computer instructions are configured to cause a computer to execute a method for path planning, and the method includes:
obtaining a path planning request, wherein the path planning request comprises a path start point and a path end point located in different areas;
determining a sequence of areas to be passed from the path start point to the path end point;
determining a plurality of boundary adjacent points on a common boundary between any two adjacent areas in the sequence of areas; and
determining a target path from the path start point to the path end point based on the path start point, the path end point, and the plurality of boundary adjacent points.

14. The storage medium according to claim 13, wherein determining the target path from the path start point to the path end point based on the path start point, the path end point, and the plurality of boundary adjacent points, comprises:
determining a plurality of candidate paths from the path start point to the path end point, each candidate path passing through at least one boundary adjacent point on at least one common boundary respective; and
determining the target path from the plurality of candidate paths.

15. The storage medium according to claim 14, wherein determining the plurality of candidate paths from the path start point to the path end point, each candidate path passing through the at least one boundary adjacent point on the at least one common boundary respective, comprises:
in response to a number of areas in the sequence of areas being at least three, obtaining a plurality of combination results by combining the plurality of boundary adjacent points on the common boundaries of the sequence of areas respectively; and
determining the plurality of candidate paths based on the path start point, the path end point and the plurality of combination results.

16. The storage medium according to claim 15, wherein determining the plurality of the candidate paths based on the path start point, the path end point, and the plurality of combination results comprises:
for each combination result, determining an area path segment between an area where the path start point is located and an area where the path end point is located based on the plurality of boundary adjacent points in the combination result;
determining a start path segment from the path start point to a boundary of the area where the path start point is located based on a boundary adjacent point located on the boundary of the area where the path start point is located and the combination result;
determining an end path segment from a boundary of the area where the path end point is located to the path end point based on a boundary adjacent point on the boundary of the area where the path end point is located and the combination result; and
obtaining a candidate path corresponding to the combination result by combining the area path segment, the start path segment, and the end path segment.

17. The storage medium according to claim 15, wherein obtaining the plurality of combination results by combining the plurality of boundary adjacent points on the common boundaries of the sequence of areas comprises:
obtaining a directed graph, wherein the directed graph comprises edges between every two adjacent common boundaries, and each edge pointing from a boundary adjacent point on one common boundary pointing to a boundary adjacent point on the other common boundary; and
obtaining the combination results of the plurality of boundary adjacent points on the common boundaries of the sequence of areas by traversing the directed graph.

18. The storage medium according to claim 14, wherein determining the plurality of candidate paths from the path start point to the path end point, each candidate path passing through the at least one boundary adjacent point on the at least one common boundary respective comprises:
in response to a number of areas in the sequence of areas being two, determining each of the plurality of candidate paths based on the path start point, the path end point, and each of the plurality of boundary adjacent points on the common boundary of two areas in the sequence of areas.
